(19) United States
(12) Patent Application Publication
(10) Pub. No.: US 2013/0176332 A1
(43) Pub. Date: Jul. 11, 2013

(54) METHOD AND APPARATUS FOR IMAGE PRESENTATION

(71) Applicant: Sakari Tapio Alenius, Lempaala (FI)

(72) Inventor: Sakari Tapio Alenius, Lempaala (FI)

(73) Assignee: NOKIA CORPORATION, Espoo (FI)

(21) Appl. No.: 13/347,145

(22) Filed: Jan. 10, 2012

(51) Int. Cl. G09G 5/00

(52) U.S. Cl. 345/629

(57) ABSTRACT

Various methods are provided for providing a transition between images. One example method may include causing an abstract image of a first image to transition on a display to a blended image. The method may also include determining the blended image based on an abstract image of the first image and an abstract image of a second image. The method may also include causing the blended image to transition on the display to the abstract image of the second image. The method may also include causing the abstract image to transition on the display to the second image.

### TECHNOLOGICAL FIELD

Embodiments of the present invention relate generally to image presentation and, more particularly, relate to a method, apparatus, and computer program product for blending multiple images during display.

### BACKGROUND

Digital images can be consumed in many different ways and on many different platforms. For example they can be viewed as individual pictures or as slide shows. The user experience generally depends on not only the quality of the images or the quality of a display, but also on the manner in which the images are displayed.

Digital images are commonly viewed as slideshows, such as in picture gallery applications or presentation application. Generally a slideshow enables each image to be displayed for a certain period of time and then the image is switched to another image. An abrupt switch from one image to another can be visual stressing, especially if the images have different intensity (e.g. lightness) or color. Some solutions attempt to combat this problem by blending the two images, forming a dynamically changing intermediate image, during a transition period.

The intermediate blended image has contributions from both images. This generally appears as a ghosting effect where visual features of both images can be seen. For most of the cases that may be acceptable, but sometimes it can be annoying or distracting to a viewer. The human vision generally tries to find something to look at even when the blended intermediate image is a meaningless mixture. As a result, the intermediate image can be confusing as the eye cannot focus on any natural object. The human vision is especially sensitive to detect faces and, for example, a mixture of faces in an intermediate image can be quite unnatural to process for the viewer. Further, the blended mixture may be accidentally unpleasant or even embarrassing if the subjects in the separate pictures appear together in the blended image in an unexpected composition.

### BRIEF SUMMARY

A method, apparatus and computer program product are therefore provided according to an example embodiment of the present invention to enable blending between images during a transition between images. In particular, the blending and transition of some example embodiments creates a special visual effect (e.g. motion, transformation, warping and/or the like). The transition of some example embodiments, includes, but is not limited to, removing the intensity (e.g. lightness) from a first image resulting in a color only image of the first image being displayed. The color only image of the first image may then be abstracted and blended with an abstracted color only image of a second image. Intensity may be added to the color only image of the second image to bring the second image into view. Thereby, the method, apparatus and computer program product are therefore configured to, for example, produce a visually stimulating transition.

In one embodiment, a method is provided that comprises causing an abstract image of a first image to transition on a display to a blended image. The method of this embodiment may also include determining the blended image based on an abstract image of the first image and an abstract image of a second image. The method of this embodiment may also include causing the blended image to transition on the display to the abstract image of the second image. The method of this embodiment may also include causing the abstract image to transition on the display to the second image.

In another embodiment, an apparatus is provided that includes at least one processor and at least one memory including computer program code with the at least one memory and the computer program code being configured, with the at least one processor, to cause the apparatus to at least cause an abstract image of a first image to transition on a display to a blended image. The at least one memory and computer program code may also be configured to, with the at least one processor, cause the apparatus to determine the blended image based on an abstract image of the first image and an abstract image of a second image. The at least one memory and computer program code may also be configured to, with the at least one processor, cause the apparatus to cause the blended image to transition on the display to the abstract image of the second image. The at least one memory and computer program code may also be configured to, with the at least one processor, cause the apparatus to cause the abstract image to transition on the display to the second image.

In the further embodiment, a computer program product may be provided that includes at least one non-transitory computer-readable storage medium having computer-readable program instructions stored therein with the computer-readable program instructions including program instructions configured to cause an abstract image of a first image to transition on a display to a blended image. The computer-readable program instructions may also include program instructions configured to determine the blended image based on an abstract image of the first image and an abstract image of a second image. The computer-readable program instructions may also include program instructions configured to cause the blended image to transition on the display to the abstract image of the second image. The computer-readable program instructions may also include program instructions configured to cause the abstract image to transition on the display to the second image.

In yet another embodiment, an apparatus is provided that includes means for causing an abstract image of a first image to transition on a display to a blended image. The apparatus of this embodiment may also include means for determining the blended image based on an abstract image of the first image and an abstract image of a second image. The apparatus of this embodiment may also include means for causing the blended image to transition on the display to the abstract image of the second image. The apparatus of this embodiment may also include means for causing the abstract image to transition on the display to the second image.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a schematic representation of an example image blending system in accordance with some example embodiments of the present invention;

FIGS. 2-6 illustrate an example image blending and transition process as performed by the example image blending system according to some example embodiments of the present invention;

FIG. 7 is an example block diagram of an example computing device for practicing some example embodiments of an image blending system; and

FIG. 8 is an example flowchart illustrating a method of operating an example image blending system performed in accordance with an embodiment of the present invention.

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term “circuitry” refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in a server, a cellular network device, or other network device.

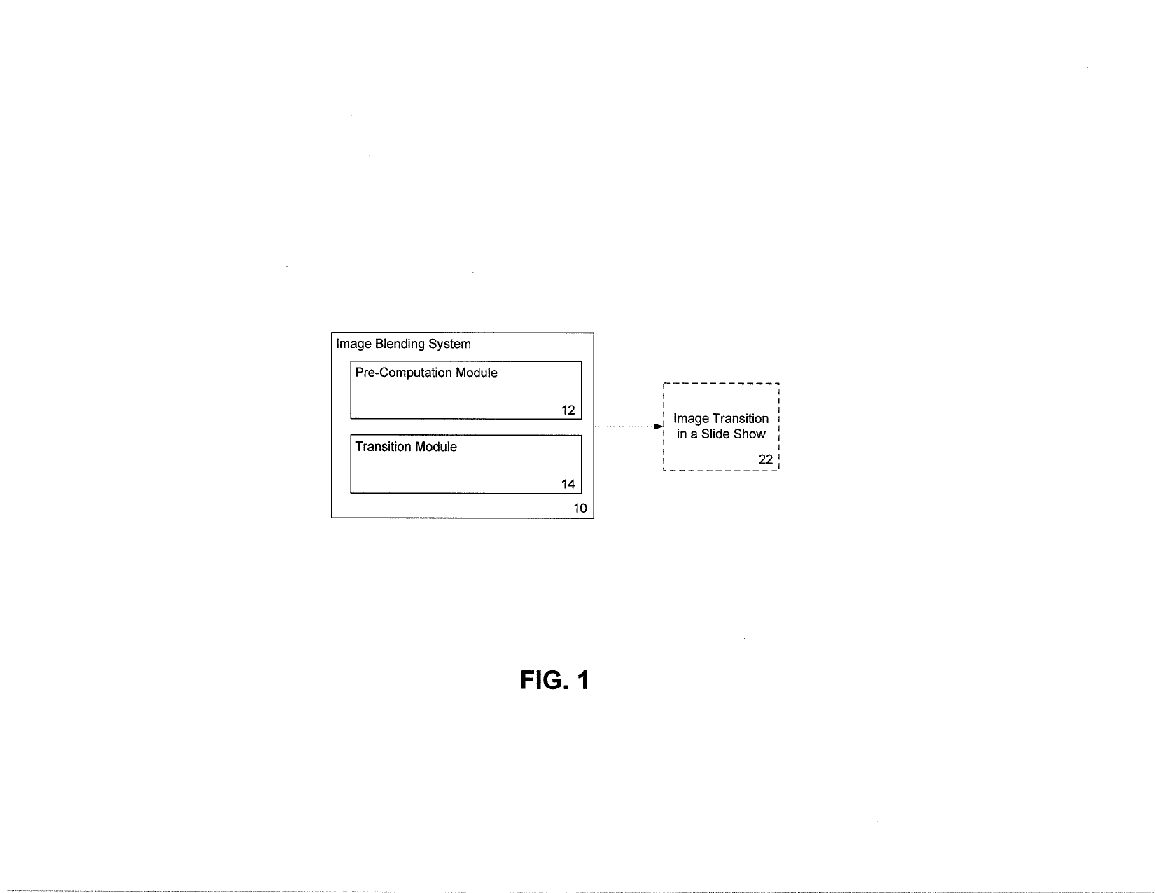

FIG. 1 is a schematic representation of an example image blending system 10 in accordance with an embodiment of the present invention. In particular the image blending system 10 may be configured to receive one or more images (e.g. video segments, photographs and/or the like). The images may be received by for example, a mobile telephone, portable digital assistant (PDA), pager, laptop computer, camera, camcorder, or any of numerous other hand held or portable communication devices, computation devices, content generation devices, content consumption devices, or any other device configured to capture an image. The image blending system 10 may then be configured to cause a first image to transition to a second image, such as the image transition in a slide show 22, using the transition and blending procedures as described herein.

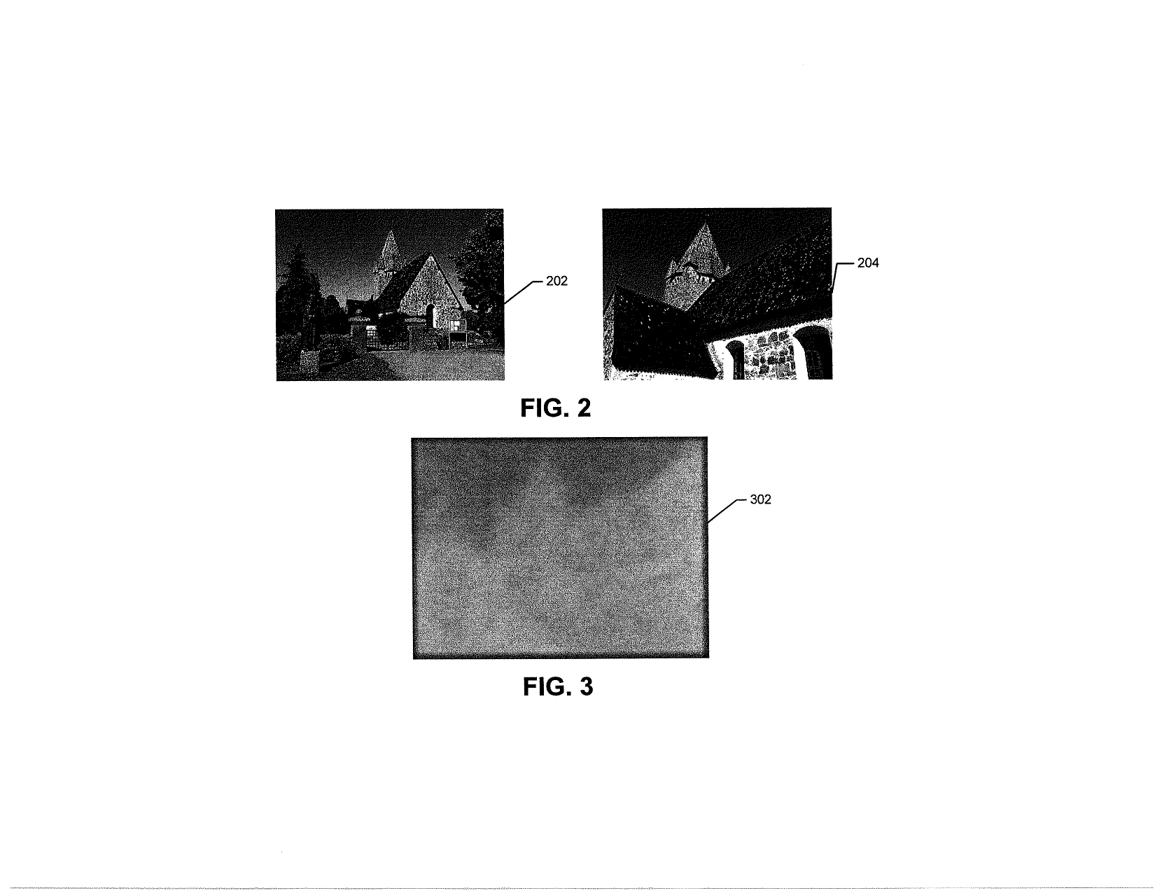

The image blending system 10 may include a pre-computation module 12 and/or a transition module 14. The example pre-computation module 12 in some example embodiments is configured to compute information related to a first image and a second image. See e.g. first image 202 and second image 204 of FIG. 2. In some embodiments, more than two images may be included and in other embodiments video, media streams and/or the like may be included. The pre-computation module 12 may be configured to compute an intensity image and color only image for both a first image (e.g. img1) and a second image (e.g. img2). See e.g. intensity image of the first image 402 and the intensity image of the second image 404 of FIG. 2. In some example embodiments, the intensity may be the length of the RGB (red, green, blue) triplet for pixel coordinates x, y. Intensity may be calculated for example by:

intensity1(x,y)=sqrt(R1(x,y)²+G1(x,y)²+B1(x,y)²)

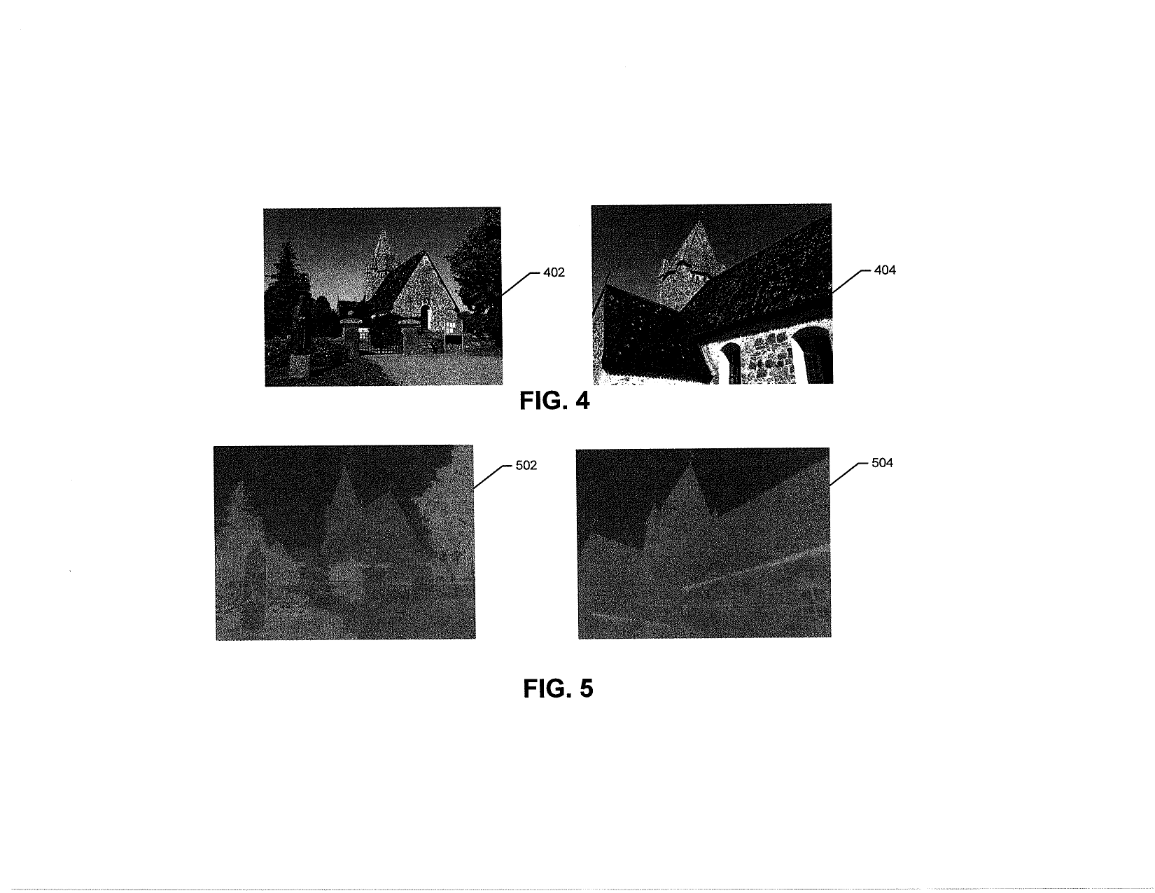

intensity2(x,y)=sqrt(R2(x,y)²+G2(x,y)²+B2(x,y)²),

Where R1 is a red channel of img1, G1 is a green channel of img1, B1 is a blue channel of img1, R2 is a red channel of img2, G2 is a green channel of img2, B2 is a blue channel of img2. See e.g. FIG. 4. Alternatively or additionally, other color models such as the YCbCr, Lab, or CMYK color model may be used.

The example pre-computation module 12 may further be configured to normalize the RGB color of the color only image for the first image or second image to create color only image of the first image and the color only image of the second image. For example each color component of a color model, such as R, G and B, may be divided by the computed intensity, for example:

nR1(x,y)=R1(x,y)/MAX(intensity1(x,y), THR)

nR2(x,y)=R2(x,y)/MAX(intensity2(x,y), THR),

Where division by zero is avoided using a predetermined threshold defined as THR. Doing the same for all RGB channels, the normalized color only image of the first image (e.g. cimg1) consists of color channels, nR1, nG1, and nB1, and the normalized color only image of the second image (e.g. cimg2) consists of color channels, nR2, nG2, and nB2. See e.g. color only image of the first image 502 and the color only image of the second image 504 of FIG. 5. Alternatively or additionally, other color models such as the YCbCr, Lab, or CMYK color models may be used.

The pre-computation module 12 may further be configured to compute a abstract image of the first color only image and an abstract image of the second color only image. In some example embodiments the abstract image of the first color only image may take the form of a blurred color image bcimg1 and the abstract image of the second color only image may take the form of a blurred color image bcimg2. See e.g. abstract image of the first image 602 and the abstract image of the second image 604 of FIG. 5. An abstract image may be computed, for example, by:

bcimg1=LP(cimg1)

bcimg2=LP(cimg2),

Where an example low-pass filter LP may be any two dimensional kernel, such as uniform N×N filter, where N can be 1/20 of the dimension of the image, and may be limited in reasonable range: 3<=N<=45. Alternatively or additionally other filters may be used as well as other definitions of N may be used. The filter does not have to be rectangular but in some example embodiments may take the shape N1×N2 (where N1 may not be equal to N2). Alternatively or additionally other processing besides the aforementioned spatial filtering may be used in order to create an abstract image, such as, but not limited to histogram operations, tonemapping, transformations, geometrical distortions, noise processing, re-sampling or re-quantization.

The pre-computation module 12 may also be configured to determine the various intensity images, color only images and abstract images so that the transition module 14 may enable the transition from a first image to a second image by using the intensity images, color only images and abstract images. As is described herein, such a transition advantageously, for example, ensures that the transition from the first image to the second image does not create conflicting stimulants to a viewer.

In some example embodiments, the transition module 14 may configured to cause a transition between the first image and the second image, such as by using a spatial transition effect. In describing the functionality of the transition module 14, reference may be made for exemplary purposes only to FIGS. 2-6 which illustrate an example image blending and transition process as performed by the example image blending system according to some example embodiments of the present invention. For example, transition module 14 may be configured to start the transition from the first image 202 to the second image 204 by removing the intensity values from the first image 202 resulting in a color only image of the first image 502. In order to transition to the color only image of the first image 502, the transition module 14, may access the determined color only image of the first image 502 as computed by the pre-computation module 12. The transition module may further cause the transition to the color only image using alpha blending. See e.g. FIG. 5. For example, alpha blending includes but not limited to blended(t)=alpha(t)*cimg1+(1−alpha(t))*img1 , where alpha varies from zero to unity in time.

Alternatively or additionally, the transition from a first image to a second image may include alternate transition effects, such as but not limited to: wipe or sweep effects such as left to right wipe, box wipe, or clock sweep can be used when implementing the transition. Other transition effects may be found with reference to Chapter 16 of the RealNetworks Production Guide dated Jul. 20, 2004 which is incorporated by reference in its entirety herein.

The transition module 14 may then be configured, in some example embodiments, to cause the color only image of the first image 502 to transition to a abstract image of the first image 602. The abstract image of the first image 602 may be determined based on the abstract image of the first image 602 computed by the pre-computation module 12. Further, the transition to the abstract image of the first image 602 may be based on alpha blending. For example, blended(t)=alpha(t)*bcimg1+(1−alpha(t))*cimg1, where alpha varies from zero to unity in time.

The transition module 14 may continue the transition by causing the abstract image of the first image 602 to the abstract image of the second image 604. For example by blended(t)=alpha(t)*bcimg2+(1−alpha(t))*bcimg1, where alpha varies from zero to unity in time. The transition module 14 may compute a blended image 302 of the abstract image of the first image 602 to the abstract image of the second image 604 based on example alpha blending. The blended image 302 may at least partially include image information from both the first image 202 and the second image 204.

The transition module 14 may further cause a transition from the blended image 302 to the abstract image of the second image 604 and resulting in the color only image of the second image 504 based on example alpha blending. The transition may be accomplished, for example based on blended(t)=alpha(t)*cimg2+(1−alpha(t))*bcimg2, where alpha varies from zero to unity in time. The transition module 14 may then cause the intensity information to be added to the color only image of the second image 504 thus resulting in the display of the second image 204. The transition may be accomplished, for example based on blended(t)=alpha(t)*img2+(1−alpha(t))*cimg2, where alpha varies from zero to unity in time.

The transition module 14 may further be configured to cause blending and transition in a media clip or video. For example, assuming img1, img2, or both are video(s), the blending procedure described herein may be used by, at each time instant the image (img1, cimg1, bcimg1, bcimg2, cimg2, or img2) is replaced by the corresponding video frame, or an image pre-computed for the given video frame.

FIGS. 2-6 illustrate an example image blending and transition process as performed by the example image blending system according to some example embodiments of the present invention. For example, FIG. 2 illustrates a first image 202 and a second image 204. By way of example the first image 202 may be transitioned to a second image 204 based on one or more of the following steps. In some embodiments, some of the steps described with reference to FIGS. 2-6 may be omitted and/or other steps may be added.

In some example embodiments, an intensity image of the first image 402 and an intensity image of the second image 404 may be calculated. The intensity image may be removed early in the transition phase in order to remove a mixture or transition that may cause conflicting stimulants to a viewer.

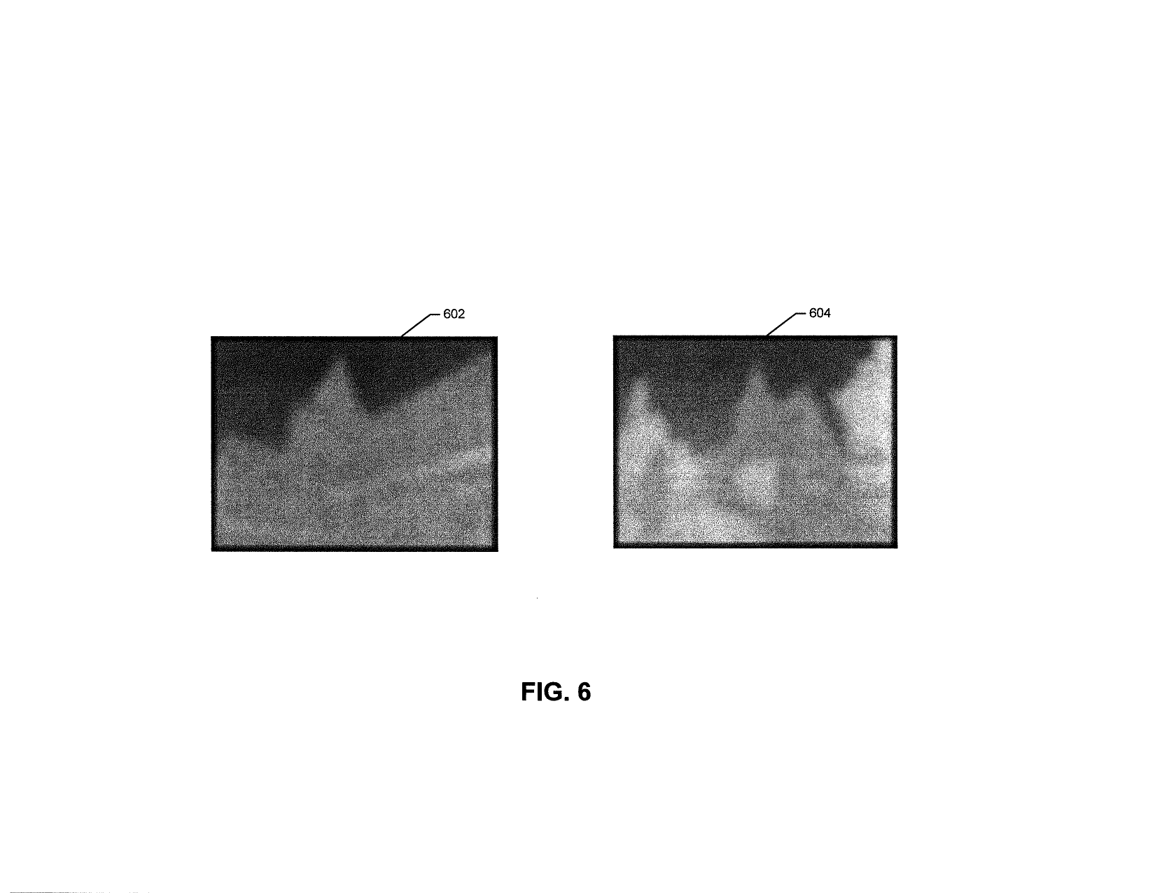

By removing intensity from an image, a color only image results. For example, a color only image of the first image 502 and a color only image of the second image 504 are shown with reference to FIG. 5. The color only images may, for example, then be blurred to create an abstract image. For example as shown in FIG. 6, which illustrates a abstract image of the first image 602 and a abstract image of the second image 604. The abstract images may be blended and may form a blended image, as is shown as blended image 302 of FIG. 3. Although the blended image 302, for example, may be a visually meaningless image, viewing the dynamically changing color mixture can be a pleasant experience and may, for example, not cause interpretation difficulties for a viewer.

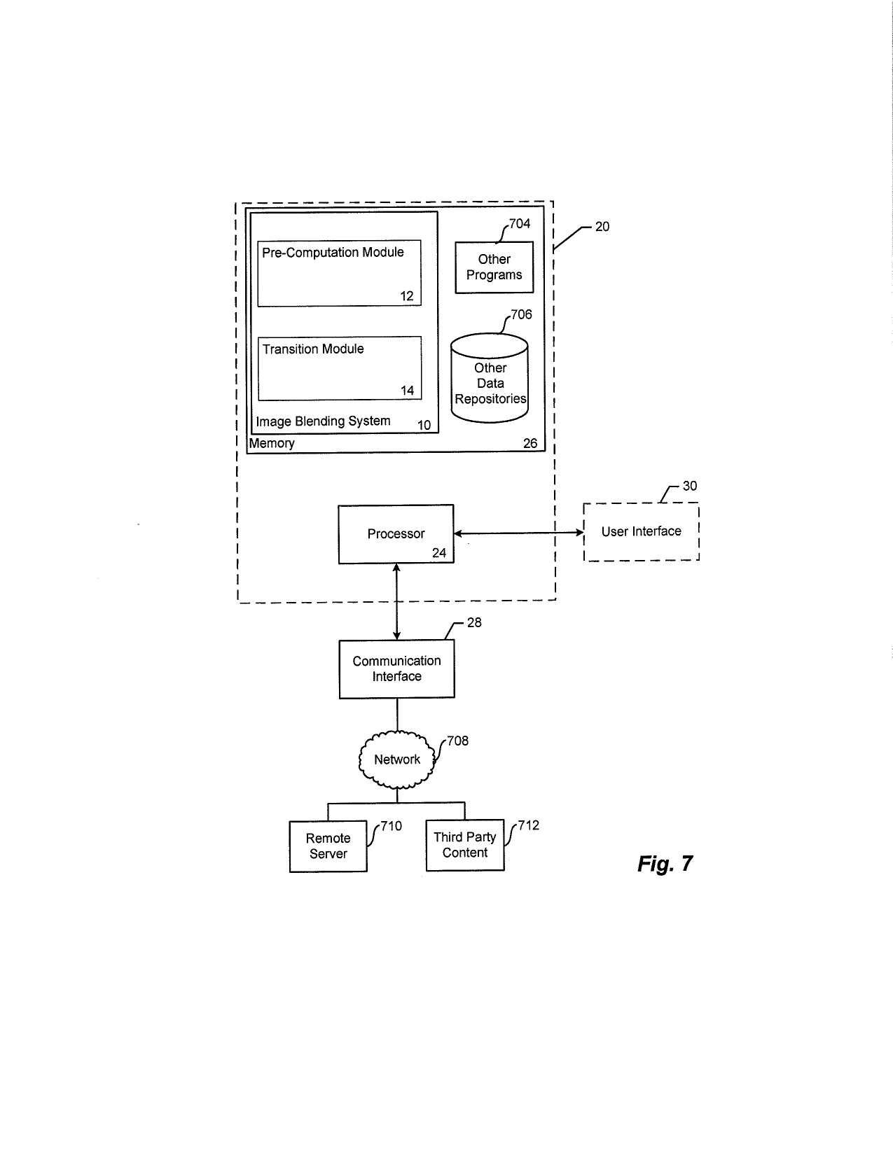

FIG. 7 is an example block diagram of an example computing device for practicing embodiments of an image processing system. In particular, FIG. 7 shows a system 20 that may be utilized to implement an image blending system 10. Note that one or more general purpose or special purpose computing systems/devices may be used to implement the image blending system 10. In addition, the system 20 may comprise one or more distinct computing systems/devices and may span distributed locations. Furthermore, each block shown may represent one or more such blocks as appropriate to a specific embodiment or may be combined with other blocks. For example, in some embodiments the system 20 may contain a pre-computation module 12 and/or a transition module 14. In other example embodiments, a pre-computation module 12 and/or a transition module 14 may be configured to operate on separate systems (e.g. a mobile terminal and a remote server, multiple remote servers and/or the like). In some example embodiments, the pre-computation module may be configured to perform the computational load and thus may be on a remote device. Whereas the transition module 14 may be on a mobile device and may be configured to perform alpha blending using software libraries and hardware accelerators native or accessible by the device. For example, the pre-computation module 12 and/or the transition module 14 may be configured to operate on a mobile terminal. Also, the image blending system 10 may be implemented in software, hardware, firmware, or in some combination to achieve the capabilities described herein.

While the system 20 may be employed, for example, by a mobile terminal and/or a stand-alone system (e.g. remote server), it should be noted that the components, devices or elements described below may not be mandatory and thus some may be omitted in certain embodiments. Additionally, some embodiments may include further or different components, devices or elements beyond those shown and described herein.

In the embodiment shown, system 20 comprises a computer memory (“memory”) 26, one or more processors 24 (e.g. processing circuitry) and a communications interface 28. The image blending system 10 is shown residing in memory 26. In other embodiments, some portion of the contents, some or all of the components of the image blending system 10 may be stored on and/or transmitted over other computer-readable media. The components of the image blending system 10 preferably execute on one or more processors 24 and are configured to stitch multidimensional images together. Other code or programs 704 (e.g., an administrative interface, a Web server, and the like) and potentially other data repositories, such as data repository 706, also reside in the memory 26, and preferably execute on processor 24. Of note, one or more of the components in FIG. 7 may not be present in any specific implementation.

In a typical embodiment, as described above, the image blending system 10 may include a pre-computation module 12 and/or a transition module 14. A pre-computation module 12 and/or a transition module 14 may perform functions such as those outlined with reference to FIG. 1. The image blending system 10 may interact via the network 708 via a communications interface 28 with one or more remote servers 710 and/or with third-party content 712. The network 708 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. In this regard, the communications interface 28 may be capable of operating with one or more air interface standards, communication protocols, modulation types, access types, and/or the like. More particularly, the system 20, the communications interface 28 or the like may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The system 20 may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

In an example embodiment, components/modules of the image blending system 10 may be implemented using standard programming techniques. For example, the image blending system 10 may be implemented as a “native” executable running on the processor 24, along with one or more static or dynamic libraries. In other embodiments, the image blending system 10 may be implemented as instructions processed by a virtual machine that executes as one of the other programs 704. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the image blending system 10, can be made available by standard mechanisms such as through C, C++, C#, and Java APIs; libraries for accessing files, databases, or other data repositories; through languages such as XML; or through Web servers, FTP servers, or other types of servers providing access to stored data. A data store may also be included and it may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the image blending system 10 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

The system 20 may be embodied as and/or implemented in any computing device, such as, for example, a desktop computer, laptop computer, mobile terminal, mobile computer, mobile phone, smartphone, mobile communication device, user equipment, tablet computing device, pad, game device, digital camera/camcorder, audio/video player, television device, radio receiver, digital video recorder, positioning device, wrist watch, portable digital assistant (PDA), fixed transceiver device (e.g., attached to traffic lights, energy meters, light bulbs, and/or the like), a chipset, an apparatus comprising a chipset, any combination thereof, and/or the like.

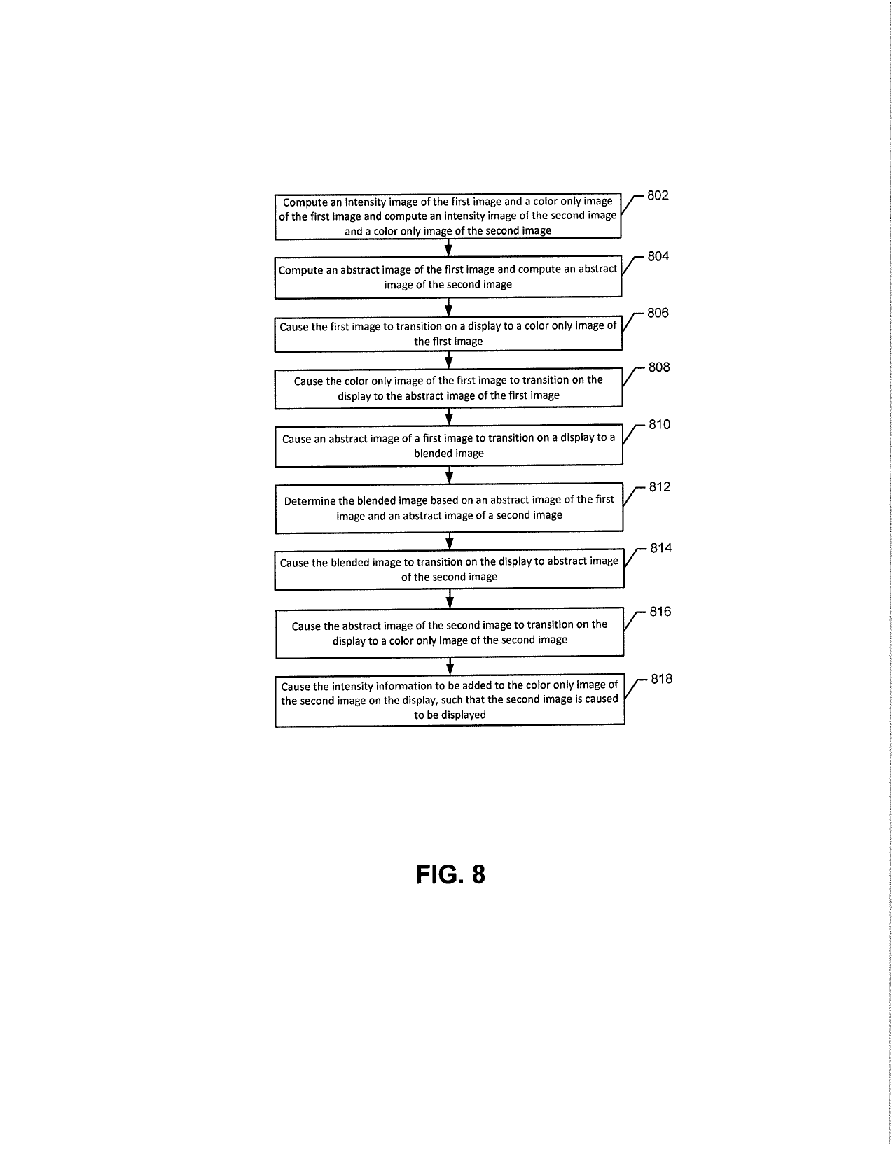

FIG. 8 illustrates an example flowchart of the example operations performed by a method, apparatus and computer program product in accordance with an embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIG. 8, when executed, convert a computer or processing circuitry into a particular machine configured to perform an example embodiment of the present invention. Accordingly, the operations of FIG. 8 define an algorithm for configuring a computer or processing to perform an example embodiment. In some cases, a general purpose computer may be provided with an instance of the processor which performs the algorithms of FIG. 8 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included. It should be appreciated that each of the modifications, optional additions or amplifications below may be included with the operations above either alone or in combination with any others among the features described herein.

FIG. 8 is an example flowchart illustrating a method of operating an example image blending system performed in accordance with an embodiment of the present invention. As shown in operation 802, the system 20 may include means, such as the image blending system 10, the pre-computation module 12, the processor 24 or the like for computing an intensity image of the first image and a color only image of the first image and computing an intensity image of the second image and a color only image of the second image. In some example embodiments, at least one of the intensity image of the first image or the intensity image of the second image may be determined based on a length of an color model triplet of a pixel in the image. In some example embodiments, at least one of the color only image of the first image or the color only image of the second image comprises a normalized color, where each color component is divided by an intensity value.

As shown in operation 804, the system 20 may include means, such as the image blending system 10, the pre-computation module 12, the processor 24 or the like for computing an abstract image of the first image and compute an abstract image of the second image. In some example embodiments, the abstract image of the first image is created by applying a low pass filter to the color only image of the first image and the abstract image of the second image is created by applying a low pass filter to the color only image of the second image.

As shown in operation 806, the system 20 may include means, such as the image blending system 10, the transition module 14, the processor 24 or the like for causing the first image to transition on a display to a color only image of the first image. As shown in operation 808, the system 20 may include means, such as the image blending system 10, the transition module 14, the processor 24 or the like for causing the color only image of the first image to transition on the display to the abstract image of the first image. As shown in operation 810, the system 20 may include means, such as the image blending system 10, the transition module 14, the processor 24 or the like for causing an abstract image of a first image to transition on a display to a blended image.

As shown in operation 812, the system 20 may include means, such as the image blending system 10, the transition module 14, the processor 24 or the like for determining the blended image based on an abstract image of the first image and an abstract image of a second image. As shown in operation 814, the system 20 may include means, such as the image blending system 10, the transition module 14, the processor 24 or the like for causing the blended image to transition on the display to the abstract image of the second image.

As shown in operation 816, the system 20 may include means, such as the image blending system 10, the transition module 14, the processor 24 or the like for causing the abstract image of the second image to transition on the display to a color only image of the second image. As shown in operation 818, the system 20 may include means, such as the image blending system 10, the transition module 14, the processor 24 or the like for causing the intensity information to be added to the color only image of the second image on the display, such that the second image is caused to be displayed.

Advantageously, the systems and methods as described herein are configured to provide a transition between images, video frames and or like by creating a visual effect, such as motion, transformation or warping. The effect, for example, replaces the practice of image ghosting that may cause visual stress or may be hard on the eyes.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
causing an abstract image of a first image to transition on a display to a blended image;
determining, using a processor, the blended image based on an abstract image of the first image and an abstract image of a second image;
causing the blended image to transition on the display to the abstract image of the second image; and
causing the abstract image of the second image to transition on the display to the second image.

2. A method according to claim 1, further comprising:
causing the first image to transition on a display to a color only image of the first image; and
causing the color only image of the first image to transition on the display to the abstract image of the first image.

3. A method according to claim 1, further comprising:
causing the abstract image of the second image to transition on the display to a color only image of the second image; and
causing an intensity image of the second image to be added to the color only image of the second image on the display, such that the second image is caused to be displayed.

4. A method according to claim 1, further comprising:
computing an intensity image of the first image and a color only image of the first image; and
computing an intensity image of the second image and a color only image of the second image.

5. A method according to claim 4, wherein the abstract image of the first image is a blurred color image and wherein the abstract image of the second image is a blurred color image.

6. A method according to claim 4, wherein at least one of the color only image of the first image or the color only image of the second image comprises a normalized color where each color component is divided by an intensity value and wherein at least one of the intensity image of the first image or the intensity image of the second image may be determined based on a length of a color model triplet of a pixel in the first image or the second image.

7. A method according to claim 1, further comprising:
computing an abstract image of the first image, wherein the abstract image of the first image is created by applying a low pass filter to a color only image of the first image; and
computing an abstract image of the second image, wherein the abstract image of the second image is created by applying a low pass filter to a color only image of the second image.

8. An apparatus comprising:
at least one processor; and
at least one memory including computer program code, the at least one memory and the computer program code configured to, with the at least one processor, cause the apparatus to at least:
cause an abstract image of a first image to transition on a display to a blended image;
determine the blended image based on an abstract image of the first image and an abstract image of a second image;
cause the blended image to transition on the display to the abstract image of the second image; and
cause the abstract image of the second image to transition on the display to the second image.

9. An apparatus according to claim 8, further comprising:
cause the first image to transition on a display to a color only image of the first image; and
cause the Color only image of the first image to transition on the display to the abstract image of the first image.

10. An apparatus according to claim 8, wherein the at least one memory including the computer program code is further configured to, with the at least one processor, cause the apparatus to:
cause the abstract image of the second image to transition on the display to a color only image of the second image; and
cause an intensity image of the second image to be added to the color only image of the second image on the display, such that the second image is caused to be displayed.

11. An apparatus according to claim 8, wherein the at least one memory including the computer program code is further configured to, with the at least one processor, cause the apparatus to:
compute an intensity image of the first image and a color only image of the first image; and
compute an intensity image of the second image and a color only image of the second image.

12. An apparatus according to claim 11, wherein the abstract image of the first image is a blurred color image and wherein the abstract image of the second image is a blurred color image.

13. An apparatus according to claim 11, wherein at least one of the color only image of the first image or the color only image of the second image comprises a normalized color where each color component is divided by an intensity value and wherein at least one of the intensity image of the first image or the intensity image of the second image may be determined based on a length of a color model triplet of a pixel in the first image or the second image.

14. An apparatus according to claim 8, wherein the at least one memory including the computer program code is further configured to, with the at least one processor, cause the apparatus to:
compute an abstract image of the first image, wherein the abstract image of the first image is created by applying a low pass filter to a color only image of the first image; and
compute an abstract image of the second image, wherein the abstract image of the second image is created by applying a low pass filter to the color only image of the second image.

15. A computer program product comprising:
at least one computer readable non-transitory memory medium having program code stored thereon, the program code which when executed by an apparatus cause the apparatus at least to:
cause an abstract image of a first image to transition on a display to a blended image;
determine the blended image based on an abstract image of the first image and an abstract image of a second image;
cause the blended image to transition on the display to the abstract image of the second image; and
cause the abstract image of the second image to transition on the display to the second image.

16. A computer program product according to claim 15, further comprising program code instructions configured to:
cause the first image to transition on a display to a color only image of the first image; and
cause the color only image of the first image to transition on the display to the abstract image of the first image.

17. A computer program product according to claim 15, further comprising program code instructions configured to:
cause the abstract image of the second image to transition on the display to a color only image of the second image; and
cause an intensity image of the second image to be added to the color only image of the second image on the display, such that the second image is caused to be displayed.

18. A computer program product according to claim 15, further comprising program code instructions configured to:
compute an intensity image of the first image and a color only image of the first image; and
compute an intensity image of the second image and a color only image of the second image.

19. A computer program product according to claim 18, wherein at least one of the intensity image of the first image or the intensity image of the second image may be determined based on a length of a color model triplet of a pixel in the first image or the second image and wherein at least one of the color only image of the first image or the color only image of the second image comprises a normalized color where each color component is divided by an intensity value.

20. A computer program product according to claim 15, further comprising program code instructions configured to:
compute an abstract image of the first image, wherein the abstract image of the first image is created by applying a low pass filter to a color only image of the first image; and
compute an abstract image of the second image, wherein the abstract image of the second image is created by applying a low pass filter to a color only image of the second image.
